(19) United States
(12) Patent Application Publication
(10) Pub. No.: US 2013/0018582 A1
(43) Pub. Date: Jan. 17, 2013

(54) Inertial Navigation Common Azimuth Reference Determination System and Method

(71) Applicants: Paul A. Miller, Harmony, PA (US); Thomas Trautzsch, Cranberry Twp., PA (US)

(72) Inventors: Paul A. Miller, Harmony, PA (US); Thomas Trautzsch, Cranberry Twp., PA (US)

(21) Appl. No.: 13/325,551

(22) Filed: Dec. 14, 2011

Related U.S. Application Data
(60) Provisional application No. 61/507,322, filed on Jul. 13, 2011.

(51) Int. Cl. G01C 21/16

(52) U.S. Cl. 701/501

(57) ABSTRACT

An inertial navigation system, including at least one personal inertial navigation module (including accelerometers, gyroscopes, and magnetometers) and at least one controller, which: obtains rotation origin data and reference magnetic field data; generates inertial navigation data using a navigation routine; generates azimuth correction data using a separate azimuth correction routine; and generates output data. Common azimuth reference determination methods are also disclosed.

### CROSS REFERENCE TO RELATED APPLICATIONS

This application claims benefit of priority from U.S. Provisional Patent Application No. 61/507,322, filed Jul. 13, 2011, which is incorporated herein by reference in its entirety.

### BACKGROUND OF THE INVENTION

1. Field of the Invention

The present invention relates generally to inertial navigation systems and methods, and in particular to a system and method for determining a common azimuth reference for one or more inertial navigation modules attached to a respective user navigating in a common frame of reference.

2. Description of the Related Art

Inertial navigation systems are used and applied in various situations and environments that require accurate navigation functionality without the necessary use of external references during the navigational process. For example, inertial navigation systems and methods are used in many indoor environments (wherein a Global Navigation Satellite System, such as the Global Positioning System, is unusable or ineffective), such as in connection with the navigational activities of a firefighter in a structure. However, in order to be effective, inertial navigation systems must initialize with estimate data, which may include data pertaining to the sensor position, velocity, orientation, biases, noise parameters, and other data. For applications without external position or common azimuth references, a system must exist to correlate the inertial navigation module relative position output or series of relative position outputs (e.g., track) and relative azimuth with some reference (e.g., another user or track, structure, external reference, etc.). In particular, such as in pedestrian navigation applications, where each inertial navigation module is attached to a user (e.g., the boot of a firefighter), a system must relate the relative position of multiple users to the same reference. This relationship provides knowledge for one user to locate another user in the absence of external knowledge or aids. Following initialization and/or turn-on, inertial navigation systems require ongoing analysis and correction to mitigate drift, bias, noise, and other external factors that affect the accuracy of these sensors and systems.

Orientation determination is a requirement for most navigation systems. In certain existing systems, an Attitude Heading Reference System (AHRS) is implemented using gyroscopes that are updated with gravity sensors (pitch and roll) and magnetic field sensors (yaw), all having excellent long-term bias stability, i.e., minimal or no drift. Further, the effective use of an AHRS, using low-cost inertial sensors, requires computationally efficient and robust algorithms to initialize and account for sensor noise and bias drift.

Position is a requirement of most navigation systems. In certain existing systems, sensors may provide information relating to position, thereby allowing an algorithm to derive position. In other systems, the sensor suite may not provide sufficient information to derive position, and therefore may require an initial position estimate for which the system propagates thereafter. A user, device, marker, or other external source may provide such a position estimate. Of particular importance in first responder applications, e.g., firefighter location and navigation, where the sensor suite may not provide sufficient information to derive position, is the establishment of a single initial position estimate, whereby the navigation routines or algorithms initialize and place all users in a global reference frame without any onerous procedural or physical requirements by the user. It is also recognized that location systems that provide a graphical user path to a central controller, such as a commander's computing device, require accurate track shape and relative track positioning between firefighters to improve situational awareness for location management.

One known initialization approach uses one or more mats to establish a common coordinate system and heading between all firefighters. In a single mat approach, the mat may contain an array of markers, such as radio frequency identification (RFID) tags or pressure sensors, which indicate the firefighter's horizontal sensor position relative to the mat's origin. As the firefighter walks across the mat, the boot-mounted inertial navigation module recognizes these inputs and aligns the module (and, thus, the user) coordinate system to match the coordinate system of the mat. A two-mat approach may also be used, where the relative position and orientation between each mat is arbitrary. In this arrangement, it is assumed that each mat represents one point, where the common coordinate system has the origin at the first mat and the x-axis extending from the first mat to the second mat. This provides a common heading or azimuth for each user.

However, it is recognized that certain situations or environments may not be amenable to a single- or two-mat-based solution. For example, the mat-based solution requires the deployment of the mats prior to the ability of the first responders to begin their navigational process. Following such deployment, the mats must remain stationary throughout the entire incident, such that all users initialize relative to the same reference, i.e., are positioned in a common navigation frame of reference. A small rotation or movement of a mat could result in significant horizontal error between those users initialized before and after this movement.

Another potential drawback to this mat-based approach is that these mats require precise location measurements for accurate azimuth alignment. This azimuth error is a function of the detection radius of each mat and the distance between the two mats. For example, if RFID-based markers (mats) are used and have a detection radius of 2.54 centimeters, with a separation of 1 meter, an azimuth error of 1.46° (and 2.5% horizontal error) results. See FIG. 1. This error is unknown to the navigation system and, therefore, cannot be recovered. Doubling the distance between the mats reduces the azimuth error and the horizontal error; however, doubling the detection radius doubles the horizontal error.

Further, the structure of the marker or mat may lead to issues based on mat size, mat weight, mat storage and transport, and deployment technique during the deployment process in an emergency situation. Effective deployment requires a substantially flat surface, where uneven ground will not allow the mat to lie flat, which therefore introduces other inaccuracies in the system. A convenient deployment location may not exist in the environment, and weather conditions may also affect or inhibit deployment.

Many navigation systems use magnetometers, which measure the surrounding magnetic field, in an ongoing process to estimate orientation (or azimuth), as well as compensate for drift errors from the integration of the angular rate data from the gyroscopes. For example, a navigation system might utilize magnetic field data to “aid” or correct orientation estimate errors using the well-known Kalman filter routines or similar algorithms. For each magnetometer measurement, an algorithm compares the magnetometer measurement to the orientation estimate and adjusts the navigation system output accordingly.

However, aiding the navigational system with magnetometers can be problematic, as the surrounding magnetic field may contain distortions resulting from ferromagnetic elements near the sensor. Depending on the environment and application, navigation systems may not be able to separate magnetic field distortions from Earth's magnetic field. Further, biases, noise, hard, and soft iron errors can produce large, abrupt disturbances that may prevent accurate estimation of the system orientation. In particular, navigation systems without external position references (e.g., firefighters), orientation errors propagate into navigation position errors (and therefore track errors).

Further, relying solely on integration of angular rate data from the gyroscopes will lead to improved estimates from the navigation routine/filter, which, in turn, leads to a more accurate navigation track shape. This condition is primarily based upon the high stability and low variance of the gyroscope measurements. Still further, gyroscopes are unaffected by magnetic disturbances while it is recognized that magnetometer bias can vary rapidly as a function of the environment. Therefore, “aiding” the navigation system and routines/filters with magnetometer data may result in inaccurate track shape and heading information.

### SUMMARY OF THE INVENTION

Generally, the present invention provides an inertial navigation common azimuth reference determination system and method that address or overcome certain drawbacks and deficiencies existing in known inertial navigation systems. Preferably, the present invention provides an inertial navigation common azimuth reference determination system and method that can be utilized in a single-point or multi-point initialization process. Preferably, the present invention provides an inertial navigation common azimuth reference determination system and method that minimize or eliminate the need for the user to engage in certain physical interactions or activities prior to starting the navigation process. Preferably, the present invention provides an inertial navigation common azimuth reference determination system and method that do not require deployment or precise (and continual) positioning. Preferably, the present invention provides an inertial navigation common azimuth reference determination system and method that do not require a separate structural device for implementation. Preferably, the present invention provides an inertial navigation common azimuth reference determination system and method that provide a common azimuth reference to all users without affecting the navigation track shape of the user.

In one preferred and non-limiting embodiment, provided is an inertial navigation system including at least one personal inertial navigation module attached to at least one user, wherein the at least one inertial navigation module comprises a plurality of sensors including: (a) at least one gyroscope configured to generate inertial data; (b) at least one accelerometer configured to generate inertial data; and (c) at least one magnetometer configured to generate measured magnetic field data; and at least one controller having a computer readable medium having stored thereon instructions, which, when executed by at least one processor of the at least one controller, causes the at least one processor to: (a) obtain or generate rotation origin data for the inertial navigation module; (b) obtain or assume reference magnetic field data for the location of a navigation frame of reference; (c) generate inertial orientation data including inertial azimuth data in the navigation frame of reference by applying at least a portion of inertial data to at least one navigation routine; (d) generate azimuth correction data by applying at least a portion of the reference magnetic field data, the measured magnetic field data, and the inertial orientation data to at least one separate azimuth correction routine; and (e) generate output data based at least in part upon the rotation origin data, the inertial navigation data, and the azimuth correction data.

In another preferred and non-limiting embodiment, provided is a computer-implemented method for determining a common azimuth reference in a navigation frame for at least one inertial navigation module having a plurality of sensors configured to generate inertial data. The method includes: (a) obtaining or generating rotation origin data for the inertial navigation module; (b) obtaining or assuming reference magnetic field data for the location of a navigation frame of reference; (c) generating inertial navigation data including inertial orientation data in the navigation frame of reference by applying at least a portion of the inertial data to at least one navigation routine; (d) generating azimuth correction data by applying at least a portion of the reference magnetic field data, the measured magnetic field data, and the inertial orientation data to at least one separate azimuth correction routine; and (e) generating output data based at least in part upon the rotation origin data, the inertial navigation data, and the azimuth correction data

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is an illustration of detection radius data for an initialization system;

FIG. 2 is an alignment vector diagram for an inertial navigation system;

FIG. 3 is a schematic view of one embodiment of an inertial navigation system according to the principles of the present invention;

FIG. 4 is a front view of another embodiment of an inertial navigation module according to the principles of the present invention and worn by a user;

FIG. 5 is a schematic view of one embodiment of an inertial navigation module according to the principles of the present invention;

FIG. 6 is a schematic view of another embodiment of an inertial navigation system according to the principles of the present invention;

FIG. 7 is a graphical representation of a correction/rotation process according to the principles of the present invention; and

FIG. 8 is another graphical representation of a correction/rotation process according to the principles of the present invention.

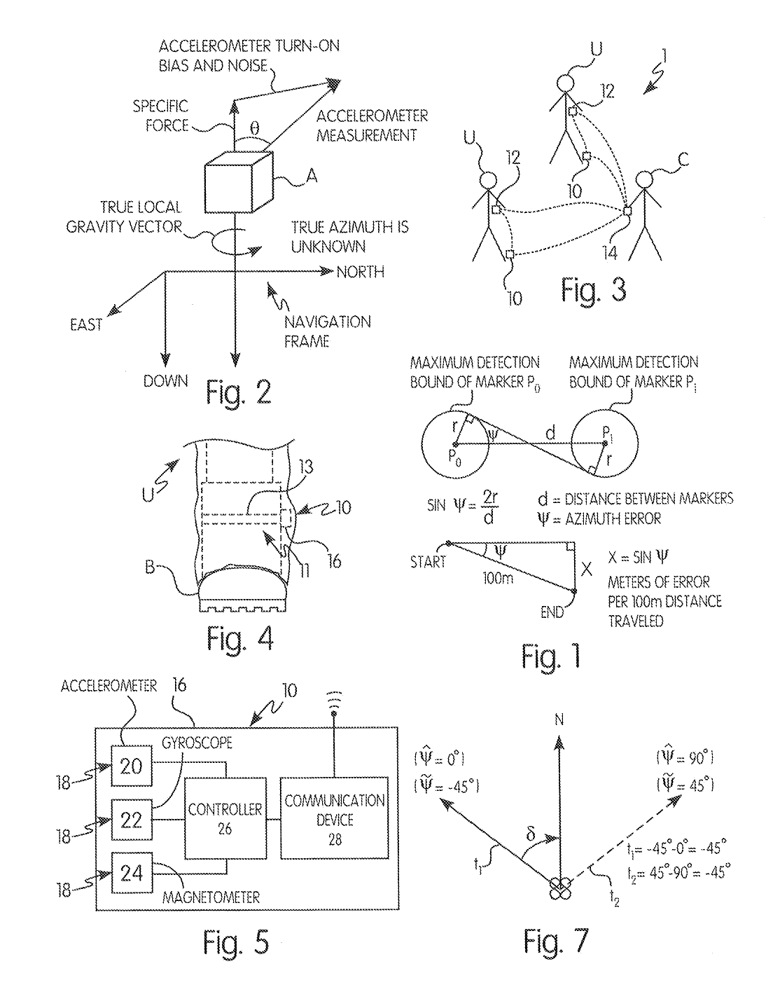

### DETAILED DESCRIPTION OF THE PREFERRED EMBODIMENTS

It is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

As discussed hereinafter, an initial consideration in the field of navigation is the reference frames, or coordinate systems, and their relationships between each other. These reference frames include the inertial frame i, the Earth-centered, Earth-fixed frame e, a north-east-down tangent frame t, and the body frame b. The inertial frame i is Earth-centered with the z axis parallel to the Earth's spin axis and passing through the North Pole. This reference frame is non-rotating, non-accelerating, and is not subject to gravity. Newton's laws apply in this frame. The Earth-centered, Earth-fixed (ECEF) frame e has an x axis extending through the intersection of the prime meridian and equator, and the z axis parallel to the Earth's spin axis and passing through the North Pole. This frame rotates about the z axis of the inertial frame with an angular rate:

ω_{i/e}≈7.292115×10⁻¹ rad/sec.

Tangent and fixed to the Earth's surface is the tangent frame t. This tangent frame has a geographic origin of latitude φ, longitude λ, and height h (φ, λ, h), with the x-axis pointing north, the y-axis pointing east, and the z-axis pointing down. The rotation between the ECEF frame and the tangent frame is:

$${R}_{e}^{t} = [ \begin{matrix}- sin φ cos λ & - sin φ sin λ & cos φ \\ - sin λ & cos λ & 0 \\ - cos φ cos λ & - cos φ sin λ & - sin φ\end{matrix} ] . \qquad ( 1 )$$

The Earth's rotation expressed in the tangent frame is:

$${ω}_{i / t}^{t} = {R}_{e}^{t} [ \begin{matrix}0 \\ 0 \\ {ω}_{i / e}\end{matrix} ] = [ \begin{matrix}cos φ \\ 0 \\ - sin φ\end{matrix} ] {ω}_{i / e} . \qquad ( 2 )$$

Finally, the body frame b navigates relative to the tangent frame, and it is assumed that the sensor frame and body frame are identical, or that they are in a substantially fixed and known mathematical relationship.

To understand the kinematic relationships between the body and inertial frames, let vector r_{i/b} describe the position of the body b relative to the inertial frame. Vector p_{i/t} describes the position of the tangent frame origin relative to the inertial frame origin. Vector r_{t/b} describes the position of the body relative to the tangent frame origin. The position of the body is as follows:

$$\begin{matrix}{r}_{i / b}^{i} = {ρ}_{i / t}^{i} + {r}_{t / b}^{i} \\ = {ρ}_{i / t}^{i} + {R}_{t}^{i} {r}_{t / b}^{t} .\end{matrix} \qquad ( 3 )$$

Differentiating (3) with respect to time yields the velocity of the body relative to the inertial frame as follows:

$$\begin{matrix}{\dot{r}}_{i / b}^{i} = {\dot{ρ}}_{i / t}^{i} + {\dot{R}}_{t}^{i} {r}_{t / b}^{t} + {R}_{t}^{i} {\dot{r}}_{t / b}^{t} \\ = {\dot{ρ}}_{i / t}^{i} + {R}_{t}^{i} {Ω}_{i / t}^{t} {r}_{t / b}^{t} + {R}_{t}^{i} {\dot{r}}_{t / b}^{t} \\ = {\dot{ρ}}_{i / t}^{i} + {R}_{t}^{i} [ {Ω}_{i / t}^{t} {r}_{t / b}^{t} + {\dot{r}}_{t / b}^{t} ] ,\end{matrix} \qquad ( 4 )$$

where matrix Ω_{i/t}^{t} is the skew symmetric form of vector ω_{i/t}^{t}. Differentiating (4) with respect to time yields the acceleration of the body relative to the inertial frame is as follows:

$$\begin{matrix}{\ddot{r}}_{i / b}^{i} = {\ddot{ρ}}_{i / t}^{i} + {\dot{R}}_{t}^{i} [ {Ω}_{i / t}^{t} {r}_{t / b}^{t} + {\dot{r}}_{t / b}^{t} ] + {R}_{t}^{i} [ {\dot{Ω}}_{i / t}^{t} {r}_{t / b}^{t} + {Ω}_{i / t}^{t} {\dot{r}}_{t / b}^{t} + {\ddot{r}}_{t / b}^{t} ] \\ = {\ddot{ρ}}_{i / b}^{i} + {R}_{t}^{i} {Ω}_{i / t}^{t} [ {Ω}_{i / t}^{i} {r}_{t / b}^{t} + {\dot{r}}_{t / b}^{t} ] + {R}_{t}^{i} [ {\dot{Ω}}_{i / t}^{t} {r}_{t / b}^{t} + {Ω}_{i / t}^{t} {\dot{r}}_{t / b}^{t} + {\ddot{r}}_{t / b}^{t} ] \\ = {\ddot{ρ}}_{i / t}^{i} + {R}_{t}^{i} [ {Ω}_{i / t}^{t} {Ω}_{i / t}^{t} {r}_{t / b}^{t} + 2 {Ω}_{i / t}^{t} {\dot{r}}_{t / b}^{t} + {\dot{Ω}}_{i / t}^{t} {r}_{t / b}^{t} + {\ddot{r}}_{t / b}^{t} ] .\end{matrix} \qquad ( 5 )$$

Solving (5) for the acceleration of the body relative to the tangent frame (i.e., \ddot{r}_{t/b}^{t}) yields:

$$\begin{matrix}{\ddot{r}}_{t / b}^{t} = {R}_{i}^{t} [ {\ddot{r}}_{i / b}^{i} - {\ddot{ρ}}_{i / t}^{i} ] - {Ω}_{i}^{t} {Ω}_{i / t}^{t} {r}_{t / b}^{t} - 2 {Ω}_{i / t}^{t} {\dot{r}}_{t / b}^{t} - {\dot{Ω}}_{i / t}^{t} {r}_{t / b}^{t} \\ = {\ddot{r}}_{i / b}^{t} - {\ddot{ρ}}_{i / t}^{t} - {Ω}_{i / t}^{t} {Ω}_{i / t}^{t} {\dot{r}}_{t / b}^{t} - 2 {Ω}_{i / t}^{t} {\dot{r}}_{t / b}^{t} - {\dot{Ω}}_{i / t}^{t} {r}_{t / b}^{t} \\ = ( {f}_{i / b}^{t} + {G}_{i / b}^{t} ) - {\ddot{ρ}}_{i / t}^{t} - {Ω}_{i / t}^{t} {Ω}_{i / t}^{t} {r}_{t / b}^{t} - 2 {Ω}_{i / t}^{t} {\dot{r}}_{t / b}^{t} - {\dot{Ω}}_{i / t}^{t} {r}_{t / b}^{t} \\ = {f}_{i / b}^{t} + ( {G}_{i / b}^{t} - {Ω}_{i / t}^{t} {Ω}_{i / t}^{t} {r}_{t / b}^{t} ) - {\ddot{ρ}}_{i / t}^{t} - 2 {Ω}_{i / t}^{t} {\dot{r}}_{t / b}^{t} - {\dot{Ω}}_{i / t}^{t} {r}_{t / b}^{t} \\ \approx {f}_{i / b}^{t} + {g}_{i / b}^{t} - 2 {Ω}_{i / t}^{t} {\dot{r}}_{t / b}^{t} ,\end{matrix} \qquad ( 6 )$$

where inertial acceleration \ddot{r}_{i/b}^{t} has been substituted with the accelerometer specific force f_{i/b}^{t} plus position dependent gravitational acceleration G_{i/b}^{t} (i.e., \ddot{r}_{i/b}^{t}=f_{i/b}^{t}+G_{i/b}^{t}). Vector g_{i/b}^{t} is the local gravity vector, represented in the tangent frame. It is assumed that the tangent frame origin is fixed, such that \ddot{p}_{i/t}=0, and the Earth rotational rate is constant, i.e., \dot{Ω}_{i/t}=0.

Expression (6) relates the total acceleration of the body with respect to the tangent frame \ddot{r}_{t/b}^{t} to the specific force vector f_{i/b}^{t}, local gravity vector g_{i/b}^{t}, and the Coriolis acceleration −2Ω_{i/t}^{t}\dot{r}_{t/b}^{t}. When stationary, the total acceleration and Coriolis acceleration are zero, thus f_{i/b}^{t}≈−g_{i/b}^{t} or f_{i/b}^{b}≈−Rₜ^{b}g_{i/b}^{t}, (7).

Rotation matrix Rₜ^{b} describes the system orientation. The specific force f_{i/b}^{b} is measured via accelerometer measurement: yₐ^{b}=f_{i/b}^{b}+bₐ^{b}+nₐ^{b}, (8), which contains sensor bias bₐ^{b} and noise nₐ^{b}. The local gravity vector, g_{i/b}^{t}, is approximated using an Earth model and knowledge of the system geodetic coordinate (φ, λ, h). Given this information, the next step is to solve for Rₜ^{b}. In particular, expression (7) is solved for Rₜ^{b} using knowledge of the local gravity vector and the accelerometer specific force measurement (8), such as through the use of the known TRIAD algorithm. Expression (7) is manipulated such that:

Rₜ^{b}=−f_{i/b}^{b}(g_{i/b}^{t})^{T}[g_{i/b}^{t}(g_{i/b}^{t})^{T}]⁻¹.

However, it also holds that g_{i/b}^{t}(g_{i/b}^{t})^{T} will always be rank 1 (i.e., not full rank), and thus a unique solution does not exist.

FIG. 2 is an alignment vector diagram for an inertial navigation system, where the system is stationary. The accelerometer triad A measures the vector sum of the specific force vector, accelerometer turn-on biases, and accelerometer measurement noise. The direction of the specific force vector may not align with the true local gravity vector as a result of bias and noise. If the accelerometer measurement does not align with the local gravity vector, a tilt error θ will result in the initial orientation estimate. FIG. 2 further illustrates that the true azimuth is unknown without an additional reference.

With continued reference to the vector diagram in FIG. 2, the specific force is known within the body frame, while the local gravity vector is known in the navigation frame. This information allows one to resolve tilt, yet provides no information concerning azimuth. Additional information is necessary to solve for Rₜ^{b}. It is necessary to have knowledge of at least two linearly independent vectors described in both the body and navigation frames to solve for Rₜ^{b} uniquely.

The TRIAD estimation method can be used to solve (7) for Rₜ^{b}, where it is assumed that the accelerometer specific force vector aligns exactly with the local gravity vector. The TRIAD input vector b₁ describes the accelerometer specific force vector. Vector r₁ describes the local gravity vector, negated. Vector r₂ is chosen to be perpendicular to r₁, where:

r₂=[1 0 0]^{T}

It is then assumed that vector b₂ is equivalent to r₂. The result of this course alignment calculation is distorted by accelerometer bias and noise, which creates a tilt error in the initial orientation estimate. Hence, a reduction in the accelerometer bias and noise will improve the initial orientation estimate.

As mentioned previously, true azimuth is unknown without the use of some external source. In certain known methodologies, the azimuth is specified or simply set to zero. In some arrangements, a magnetometer may provide an initial azimuth where vector b₂ represents the magnetic field measurement and vector r₂ represents a reference magnetic field vector. Magnetometer biases, noise, and magnetic disturbances may degrade the accuracy of this initial azimuth estimate. In other arrangements, and as previously discussed, the azimuth can be obtained using a marker or mat-based approach. However, the present invention relates to a unique system and method that utilizes information and data from a magnetometer during the navigation process to determine a common azimuth reference for one or more users.

In general, and in one preferred and non-limiting embodiment illustrated in FIG. 3, the present invention is directed to an inertial navigation system 1, which includes at least one inertial navigation module 10, a personal communication device 12, and an onsite computer 14. The inertial navigation module 10 (e.g., a personal inertial navigation unit) is typically portable and removably attached to a user U, e.g., a firefighter, such as on a boot B of the user U (see FIG. 4). In particular, the inertial navigation module 10 can be secured to or integrated with the boot B of the user U through any known attachment arrangement 11, such as a strap 13 or the like. Of course, the inertial navigation system 1 normally includes multiple users U navigating at the same site or scene. Accordingly, multiple, respective inertial navigation modules 10 are normally used simultaneously during a navigation event.

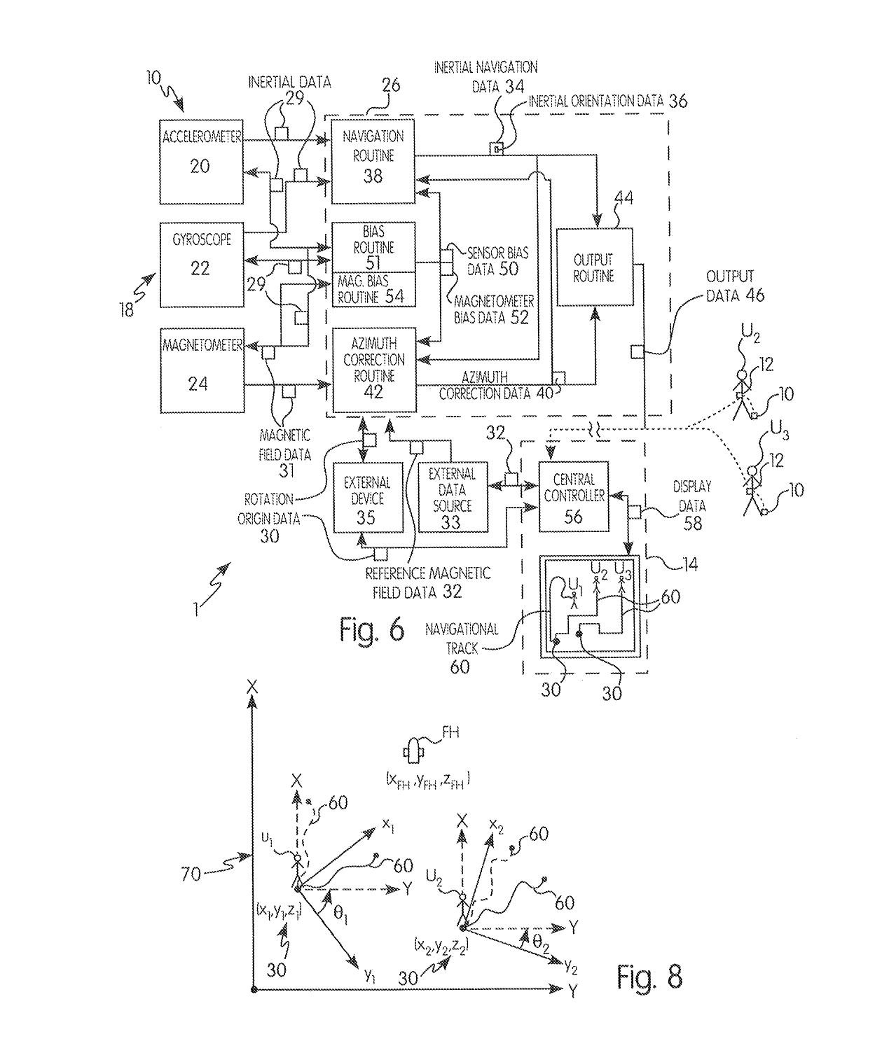

Further, and with reference to FIGS. 4 and 5, the inertial navigation module 10 includes a housing 16 surrounding at least one sensor 18. The inertial navigation module 10 typical includes multiple sensors 18, such as at least one accelerometer 20, at least one gyroscope 22, and at least one magnetometer 24, or the like. It should be noted that, as used hereinafter, an accelerometer 20 may comprise a unit or sensor that is configured or arranged to measure specific force and generate inertial data 29, as shown in FIG. 6. The inertial data 29 from the accelerometer 20 is representative of specific force data along one or more axes, e.g., the x-, y-, and z-axis, and is normally configured as an accelerometer triad, i.e., an x-accelerometer, a y-accelerometer, and a z-accelerometer). Accordingly, given knowledge of the system orientation, initial velocity, initial position, local gravity vector, and Earth rate, the output of the accelerometer 20 can be integrated to obtain a velocity estimate, and then integrated again to obtain a position estimate in each of the x-, y-, and z-directions. These values are used in succession to calculate a new location estimate.

As used herein, the accelerometer may be used alone, but are normally used in connection with a gyroscope 22 (or other sensors) in the context of the inertial navigation module 10 operating in an inertial navigation system 1. The output of the gyroscope 22 (i.e., rotational sensor) also includes inertial data 29, e.g., angular rotation data, which, like the accelerometer 20, can be measured or determined in connection with one or more axes (i.e., a gyroscope triad). The inertial data 29 from the gyroscopes 22 is, for example, integrated with respect to time to determine the sensor 18 change in orientation. This change in orientation propagates the direction cosine matrix (DCM) representing the orientation Rₜ^{b} of the module 10.

As used herein, a magnetometer 24 can be used to generate measured magnetic field data, e.g., directional data with respect to magnetic north. Like the accelerometers 20 and the gyroscopes 22, a magnetometer triad is used to measure this magnetic field data 31 along or about its respective axis. The use of one or more magnetometers 24 in the system 1 and methods of the present invention are central to the correction and/or rotation of a user's U track as they navigate in the navigation frame. Further, these magnetometers 24 may be in the form a foot-mounted magnetometer 24, which is arranged on or in the inertial navigation module 10.

Further, and in this preferred and non-limiting embodiment, the inertial navigation module 10 includes a controller 26 that is programmed or configured to interface with the sensors 18 and obtain the necessary data to perform certain automated calculations and determinations (e.g., the above-discussed integrations and other calculations performed through the execution of various navigation, filtering, and/or determination routines, calculations, and/or algorithms). This resulting data can be processed, transmitted, and/or delivered for use in further processes or in connection with additional calculations and determinations and data generation, as set forth and discussed above and hereinafter. As is known, this controller 26 can be in the form of any appropriate computing device, such as a computer including a computer readable medium having stored thereon instructions, which, when executed by at least one processor of the computer, causes the at least one processor to implement or execute the appropriate algorithms and method steps. Further, each sensor 18 may include a control device and/or a computing device for analog-to-digital conversion and/or pre-processing of the raw data into another useful data form or format.

The navigation data and/or the determinations and resultant data can be used within the inertial navigation system 1 in order to facilitate the effective tracking of multiple users U or objects in a given environment. It should further be noted that the controller 26 may be remote from the inertial navigation module 10, and can receive the raw, measured, or pre-processed, or processed data through wireless or hardwired communication. Preferably, however, the controller 26 is positioned locally and within the housing 16 of the inertial navigation module 10, i.e., the personal inertial navigation unit. Still further, and with reference to the various calculations and determinations made hereinafter, the routines and/or algorithms executed by the computing device (e.g., the controller 26) can be made at any point in the process and locally on the inertial navigation module 10, at the personal communication device 12, and/or remotely at the onsite computer 14, including the central controller 56 (as discussed hereinafter). Accordingly, any one or more of the steps discussed herein can be implemented on the controller 26 (i.e., local to the user U), on the central controller 56 (i.e., remote from the user U), or any combination thereof, whether the step is data collection, data input, data processing, data generation, and/or data output. Similarly, all communication between any of the components of the system 1 can be wired, wireless, direct, indirect, one-way, two-way, or any combination thereof.

The inertial navigation module 10 may be in wireless communication, via a local communication device 28, with the personal communication device 12, which is also worn by the user U, typically on the user's jacket. The personal communication device 12 is programmed or configured to wirelessly transmit data to the onsite computer 14, which is normally operated by a site coordinator C, e.g., the commander. It is further envisioned that any raw, measured, or pre-processed, or processed data can be transmitted directly from the inertial navigation module 10 to the onsite computer 14, or some other desired destination.

Generally, the data and information generated or output by the accelerometers 20 and gyroscopes 22 is referred to herein as inertial data 29. Accordingly, in one preferred and non-limiting embodiment, the accelerometers 20 and gyroscopes 22 are configured to generate or output analog data, digital data, raw data, pre-processed data, processed data, and the like. As discussed above, any of the inertial data generated or output by the accelerometers 20 is derived from the measurements of specific force, while any of the data generated or output by the gyroscopes 22 is derived from the measurements of angular rotation or rate. Further, in one preferred and non-limiting embodiment, the magnetometers 24 are configured to generate or output measured magnetic field data 31. Of course, it is recognized that, like the accelerometers 20 and gyroscopes 22, the magnetometers 24 may also include interface logic or otherwise be configured to generate or output analog data, digital data, raw data, pre-processed data, processed data, and the like.

In another preferred and non-limiting embodiment, as illustrated in FIG. 6, the system 1 includes the above-discussed sensors 18, including the accelerometers 20, gyroscopes 22, and magnetometers 24. Further, the controller 26 (and/or the central controller 56) is configured or programmed to: obtain or generate rotation origin data 30 for the inertial navigation module (or, in the case of multiple users U having the same or distinct origins, the rotation origin data 30 for each of the multiple inertial navigation modules 10 (each attached to a respective specific user U)); and obtain reference magnetic field data 32 for the general navigation location (or site at which the users U are navigating). This reference magnetic field data 32 includes the local magnetic field characteristics, and is utilized in translating between magnetic north and true north. In particular, and typically based upon obtained Global Positioning System (GPS) coordinates, the reference magnetic field data 32 can be received or obtained from a third-party source or external data source 33, such as the National Oceanic and Atmospheric Administration (NOAA).

Next, the controller 26 (and/or central controller 56) is programmed or configured to: (1) generate inertial navigation data 34 including inertial orientation data 36 in the navigation (global) frame of reference (i.e., the tangent frame) by applying at least a portion of the inertial data 29 to at least one navigation routine 38 (such as a navigation program, algorithm, calculation, or the like); (2) generate azimuth correction data 40 by applying at least a portion of the reference magnetic field data 32, the measured magnetic field data 31, and the inertial orientation data 36 (and/or any of the inertial data collected in the system 10) to at least one separate azimuth correction routine 42 (such as a program, algorithm, calculation, or the like); (3) generate output data 46 (e.g., track-related data, track correction data, and the like) based at least in part upon the rotation origin data 30, the inertial navigation data 34, and the azimuth correction data 40. In particular, the output data 46 can be generated or provided using an output routine 44, such as in the form of a program, algorithm, calculation, or the like.

Again, any of these determinations and calculations can be made at any appropriate and programmed computing device within the system 1. For example, as shown in FIG. 6, the output routine 44 may be programmed on the controller 26, such that the output data is transmitted to the onsite computer 14 (and/or central controller 56). Alternatively, the output routine 44 may be programmed directly on the onsite computer 14 (e.g., on the central controller 56), such that this centrally-located onsite computer 14 has access to all of the individual inertial data 29, inertial navigation data 34, inertial orientation data 36, and/or azimuth correction data 40. Likewise the rotation origin data 30 and/or the reference magnetic field data 32 can be obtained or generated by the central controller 56 (as discussed hereinafter). Accordingly, the onsite computer 14 can perform comparative analysis between sets of users U and their associated data in order to improve the overall navigation accuracy of the system 1. Again, the controller 26 that makes the determinations and calculations noted above may be local to the user U, remote from the user U, or the processing may occur separately or redundantly in multiple controllers or processors. Therefore, controller 26 (and/or central controller 56) refers to a computer, processor, or device that is capable of processing data and providing data output for further use in the system 1.

By using a separate (i.e., independent) azimuth correction routine 42, the azimuth or heading of each user U can be obtained separate and apart from the inertial navigation data 34 determinations, which are derived from the inertial data 29 of the accelerometers 20 and the gyroscopes 22. In this manner, the inertial navigation data 34 is not impacted by the magnetometer 24 measurements and data derived therefrom, and vice versa. This ensures that the shape of each user's U track is not impacted by any variance or bias of the magnetometers 24, which would degrade the track shape if the data from the magnetometers 24 were used in the navigation routine 38. Therefore, this separation of routines 38, 42 leads to an improved track shape, which can be rotated (about each common or distinct rotation origin of each user U) based upon the user-specific output data 46 (as at least partially generated by the output routine 44). Accordingly, in this preferred and non-limiting embodiment, the data from the azimuth correction routine 42 is used to rotate the user's U track and does not act as an aid to the ongoing navigation routine 38.

The initial sensor bias data 50 can be used in connection with the navigation routine 38 to provide the inertial navigation data 34. Further, the initial sensor bias data 50 can be periodically or continually updated during additional stationary intervals to provide updated sensor bias data 50 using a bias routine 51 or filter. This updated sensor bias data 50 can then be utilized in the navigation routine 38 and lead to improved inertial navigation data 34. It is further noted that the initial or updated sensor bias data 50 can be generated at or before the user U begins navigation. This leads to improved and/or converged sensor bias data 50, thus providing improved inertial navigation data 34.

In one preferred and non-limiting embodiment, the magnetometers 24 are “powered on” as soon as the user U attaches the inertial navigation module 10. Further, initial and subsequent magnetometer bias data 52 from the magnetometers 24 can be estimated by applying at least a portion of the reference magnetic field data 32 and the measured magnetic field data 31 to a magnetometer bias routine 54. This magnetometer bias data 52 is updated during the navigation process using the magnetometer bias routine 54 and applied in the azimuth correction routine 42 to account for bias, jitter, and/or noise. Still further, any of the bias data 50, 52 determined for the sensors 18 (accelerometers 20, gyroscopes 22, and/or magnetometers 24) can be used in the correction determination routine 42.

As further illustrated in the embodiment of FIG. 6, the system 1 includes the central controller 56 (e.g., the onsite computer 14), which is normally remote from the inertial navigation modules 10 of the users U. This central controller 56 is programmed or configured to generate display data 58 based at least in part upon output data 46 (which also may be determined by the central controller 56, as discussed above), and this display data 58 includes data sufficient to display or create a navigational track 60 of each user U. In particular, this navigational track 60 is rotated about the rotation origin of each user U in the navigation (global) frame of reference and displayed on a display device 62, such as a monitor or screen associated with the controller 56 (or onsite computer 14). It is also noted that the display data 58 can be generated: (1) dynamically (as at least partially based upon the dynamically-generated output data 46); (2) periodically; or (3) at a specified point or threshold (e.g., after the magnetometer bias data 52 has reached an acceptable level, or after the azimuth correction data 40 for one or more of the users U has converged to an acceptable level). In addition, the controller 26 or central controller 56 may include a measurement validation routine, which discards certain data points of the measured magnetic field data 31, thereby preventing the use of incorrect or aberrant data by the azimuth correction routine 42. Again, the central controller 56 can be configured or programmed to implement any of the data-centric and/or processing steps or routines within the context of the presently-invented system 1.

In another preferred and non-limiting embodiment, the reference magnetic field data 32 is automatically obtained by the inertial navigation module 10, i.e., the controller 26, from the external data source 33, such as a database of the NOAA. Alternatively, this data and information can be obtained or assumed from a locally-situated database (e.g., on the inertial navigation module 10, the central controller 56, and the like), a model, user U input, and the like.

In a further preferred and non-limiting embodiment, the common or distinct rotation origin data 30 (e.g., the rotation origin point) for each inertial navigation module 10 is generated through some interaction between the inertial navigation module 10 and a reference point determined by the module 10 and/or some external reference. For example, a direct or indirect interaction between the user U (and, in particular, the user's U inertial navigation module 10) and some external device 35 (e.g., a tag-in point or a portable initialization station) serves to generate the rotation origin of each user U, whether that initial (or subsequent) rotation origin point is common to one or more users U, or different between the multiple users U (e.g., multiple tag-in points, portable initialization stations, or the like). Thereafter, each of the user's navigational tracks 60 can be effectively rotated about the rotation origin point based upon the magnetic field data 31 and the azimuth correction routine 42. Further, this rotation origin data 30 can be provided by the external device 35 to the local controller 26, the central controller 56, or any combination thereof.

In this manner, the shape of the navigational track 60 is not altered; instead, the navigational track 60 is rotated about each user's rotation origin point. Therefore, all of the users U are effectively tracked and displayed on the display device 62 in the common navigation (global) frame of reference. Further, the calculation and determination of the output data 46 can be performed dynamically, periodically, and/or on a predetermined basis. As the data from a magnetometer bias routine 54 converges and the azimuth correction data 40 (estimate) becomes more accurate, the user's U navigational track 60 can be rotated at any point during the navigational process, and periodically checked to ensure continued accuracy. It is also envisioned that any of the data generated by or determined during implementation and use of the present invention can be used to check other data points of the user U or even between users U.

### EXAMPLE

In one exemplary operating embodiment of the present invention in the firefighter location implementation, and upon powering the inertial navigation module 10, the initial orientation data is estimated, and this estimate can be based upon the above-discussed two-vector measurement of non-zero, non-collinear quantities within their respective coordinate frames. The course alignment is utilized by the navigation routine 38 during a stationary interval, where total acceleration \ddot{r}_{t/b}^{t} and Coriolis acceleration −2Ω_{1/t}^{t}\dot{r}_{t/b}^{t} are zero: \ddot{r}_{t/b}^{t}≈f_{t/b}^{f}+g_{t/b}^{t}−2Ω_{i/t}^{t}\dot{r}_{t/b}^{t} (9), resulting in f_{t/b}^{b}≈Rₜ^{b}g_{t/b}^{t}, (10).

In this example, initial orientation data estimates are determined using the sub-optimal quaternion TRIAD algorithm, where it is assumed that the specific force vector, f_{t/b}^{b}, in equation (10) aligns perfectly with the local gravity vector, g_{t/b}^{t}. It is known that accelerometer 20 noise, nₐ, and biases, bₙ, produce alignment errors with an inherent inability for the sensor 18 to provide accurate orientation estimates about vertical. Without some additional aiding measurements, or interaction from the user U (e.g., the above-discussed two-mat arrangement), and as discussed above, an accurate heading estimate is not feasible. Further, it should be noted that firefighters (as with most emergency response personnel) require a quick initialization method, which does not impede their mission. Upon exiting the fire truck, and in this example, it is assumed that the inertial navigation module 10 has been powered for a length of time (i.e., “warmed up”), such that the accelerometer 20 and gyroscope 22 biases are no longer rapidly varying with temperature.

In lieu of a two-point initialization (using markers, mats, and the like), the present invention utilizes the above-described process, including the magnetometer bias routine 54 to calibrate, in-situ, the magnetometer biases, bₘ, for use in determining the azimuth correction data 40. As discussed, it is assumed that all firefighters experience a similar local magnetic field, therefore allowing the reference magnetic field data 32, measured magnetic field data 31, and inertial data 29 for each inertial navigation module 10 to be used in the separate azimuth correction routine 42.

In this exemplary and non-limiting embodiment, the magnetometer bias data 52 is estimated using the TWOSTEP algorithm (as the magnetometer bias routine 54), which is a sequential algorithm based on determining the differences between the actual and measured unit vectors. It is anticipated that the magnetometer biases, scale factors, and non-orthogonality corrections can be calibrated continuously throughout the firefighter's mission.

Using the initial magnetometer bias vector (magnetometer bias data 52), inertial navigation data 34, inertial orientation data 36, magnetic field data 31, and reference magnetic field data 32, the azimuth correction routine 42 estimates the azimuth correction data 40. In the exemplary and non-limiting embodiment, a stochastic filter (i.e., Kalman filter, unscented Kalman filter, information filter, and the like) estimates the magnetometer biases, magnetometer scale factor errors, and azimuth correction data 40 in the azimuth correction routine 42. In another preferred and non-limiting embodiment, an Attitude Heading Reference System (AHRS) estimates a separate AHRS azimuth angle, and then computes the azimuth correction data 40 via the difference between the inertial azimuth angle and AHRS azimuth angle in the azimuth correction routine 42.

The rotation error (e.g., included as at least a portion of the azimuth correction data 40) is the difference between the inertial azimuth estimate and the azimuth estimate after incorporating magnetic field data 31. Preferably, central controller 56 uses this azimuth correction data 40 to rotate the user's U navigational track 60 about the relative origin (rotation origin) of the user U. Accordingly, and as discussed, the track generated by the navigation routine 38 is undistorted by the magnetometer 24 biases. This results in a more accurate track shape for each user U, where all of the navigational tracks 60 are emitting in the correct and common direction. One graphical representation of this correction/rotation process is illustrated in FIG. 7.

A further graphical representation of one implementation of the system 1 and method of the present invention is provided in FIG. 8. As seen in this figure, two users U₁ and U₂ are navigating in the navigation (or global) frame of reference 70, as represented in the coordinate system (X, Y, Z). Also present in this navigation frame of reference 70 is an object, e.g., a fire hydrant FH. Each of the users U₁, U₂ are represented in their specific (user) frame of reference as (x₁, y₁, z₁) and (x₂, y₂, z₂), and the fire hydrant FH is placed or can be directly placed in the navigation frame of reference 70 as (X_{FH}, Y_{FH}, Z_{FH}) either through relationship with a user U and/or some external reference. Further, the rotation origin data 30 for the first user U₁ and the second user U₂ can be any known arbitrary point (x₁, y₁, z₁) and (x₂, y₂, z₂), respectively. Accordingly, the rotation origin data 30 for each respective user U₁, U₂ may be the turn-on point (0, 0, 0), an initialization point, and/or some other arbitrary point after navigation has begun, e.g., a tag-in point or other known point in the navigation frame of reference 70. The presently-invented system 1 and method are used to correct and/or rotate the navigational track 60 of each user U₁, U₂ to accurately place them in the navigation frame of reference 70. This permits the central controller 56 (e.g., the onsite computer 14) to effectively identify and track all of the users U₁, U₂, as well as the objects in the environment, e.g., the fire hydrant FH, in a single, global frame of reference, i.e., the navigation frame of reference 70. Accordingly, by establishing a common azimuth reference, one or more users U can be tracked and assisted in navigating at the scene, which is represented in the navigation (global) frame of reference 70.

In this manner, the present invention provides a unique and accurate system and method to determine a common azimuth reference for one or more users U (and/or between a user U and another external reference) in a navigation (global) frame of reference 70, using magnetometer 24 data and a separate azimuth correction routine 42. As discussed, this approach differs from other known navigational systems, since typical navigational systems only utilize magnetometers to aid the navigation routine (or process), itself. In many applications, magnetometer aiding provides a reliable estimate of true north. Additional aiding techniques may be used to correct position and velocity, and thus minimize the effect of magnetic anomalies.

However, the present invention provides accurate unaided position estimation from initialization (and on an ongoing basis). Accordingly, if a magnetometer 24 would be used in the known manner, momentary magnetic anomalies would cause variation in azimuth, which would lead to resulting distortions in the navigational track 60. Integration of the gyroscope-based data alone produces a more accurate track shape, such that the present invention uses this separate azimuth correction routine 42 (and/or separate magnetometer bias routine 54) to determine a common azimuth reference, which does not affect the primary navigation routine 38 or the shape of the navigational track 60.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent units that are within the spirit and scope of the appended claims. For example, it is to be understood that the present invention contemplates that, to the extent possible, one or more features of any embodiment can be combined with one or more features of any other embodiment.

What is claimed is:

1. An inertial navigation system, comprising:
at least one personal inertial navigation module attached to at least one user, wherein the at least one inertial navigation module comprises a plurality of sensors comprising:
(a) at least one gyroscope configured to generate inertial data; (b) at least one accelerometer configured to generate inertial data; and (c) at least one magnetometer configured to generate measured magnetic field data; and
at least one controller having a computer readable medium having stored thereon instructions, which, when executed by at least one processor of the at least one controller, causes the at least one processor to:
(a) obtain or generate rotation origin data for the inertial navigation module;
(b) obtain or assume reference magnetic field data for the location of a navigation frame of reference;
(c) generate inertial navigation data including inertial orientation data in the navigation frame of reference by applying at least a portion of inertial data to at least one navigation routine;
(d) generate azimuth correction data by applying at least a portion of the reference magnetic field data, the measured magnetic field data, and the inertial orientation data to at least one separate azimuth correction routine; and
(e) generate output data based at least in part upon the rotation origin data, the inertial navigation data, and the azimuth correction data.

2. The system of claim 1, wherein, prior to step (c), the inertial navigation module is initialized by generating initial orientation data and initial sensor bias data for at least one of the following: the at least one gyroscope, the at least one accelerometer, the at least one magnetometer, or any combination thereof.

3. The system of claim 2, wherein at least a portion of the initial orientation data and the initial sensor bias data is used in the at least one navigation routine of step (c).

4. The system of claim 2, wherein at least a portion of the initial sensor bias data is updated to provide updated sensor bias data, and at least a portion of the updated sensor bias data is used in the at least one navigation routine of step (c).

5. The system of claim 1, wherein at least steps (c)-(d) are repeated for a plurality of time increments, thereby determining a plurality of azimuth correction data points.

6. The system of claim 5, wherein the output data comprises converged azimuth correction data based upon at least a portion of the plurality of azimuth correction data points.

7. The system of claim 1, wherein the at least one processor is further configured to estimate bias data for the at least one magnetometer of the inertial navigation module by applying at least a portion of the reference magnetic field data and the measured magnetic field data to at least one magnetometer bias routine.

8. The system of claim 7, wherein the bias data is updated during navigation using the magnetometer bias routine and applied in the azimuth correction routine to account for at least one of the following: bias, jitter, noise, or any combination thereof.

9. The system of claim 7, wherein the bias data for the inertial navigation module is at least partially applied in the azimuth correction routine.

10. The system of claim 1, wherein the at least one processor is further configured to generate display data based at least in part upon the output data, wherein the display data comprises a navigational track of the at least one user.

11. The system of claim 10, wherein the navigational track is rotated about a rotation origin in the navigation frame of reference, and displayed on at least one display device.

12. The system of claim 1, wherein at least one data point of the measured magnetic field data is discarded if the data point is rejected by at least one measurement validation routine.

13. The system of claim 1, wherein the reference magnetic field data is automatically obtained by the at least one processor from at least one external data source.

14. The system of claim 1, wherein the reference magnetic field data is obtained by the at least one processor from at least one of the following: a local database, a model, a user, an external reference, or any combination thereof.

15. The system of claim 1, wherein the rotation origin data for the inertial navigation module is generated through a direct or indirect interaction between the inertial navigation module and a reference point determined by at least one of the inertial navigation module and an external reference.

16. The system of claim 1, further comprising a plurality of inertial navigation modules, wherein steps (c)-(e) are implemented for each of the plurality of inertial navigation modules.

17. A computer-implemented method for determining a common azimuth reference in a navigation frame for at least one inertial navigation module having a plurality of sensors configured to generate inertial data, the method comprising:
(a) obtaining or generating rotation origin data for the inertial navigation module;
(b) obtaining or assuming reference magnetic field data for the location of a navigation frame of reference;
(c) generating inertial navigation data including inertial orientation data in the navigation frame of reference by applying at least a portion of the inertial to at least one navigation routine;
(d) generating azimuth correction data by applying at least a portion of the reference magnetic field data, the measured magnetic field data, and the inertial orientation data to at least one separate azimuth correction routine; and
(e) generating output data based at least in part upon the rotation origin data, the inertial navigation data, and the azimuth correction data.

18. The method of claim 17, wherein, prior to step (c), the inertial navigation module is initialized by generating initial orientation data and initial sensor bias data for at least one of the following: at least one gyroscope, the at least one accelerometer, at least one magnetometer, or any combination thereof, during at least one initial stationary interval.

19. The method of claim 17, further comprising generating bias data for at least one magnetometer of the inertial navigation module by applying at least a portion of the reference magnetic field data and the measured magnetic field data to at least one magnetometer bias routine.

20. The method of claim 19, wherein at least a portion of the bias data for the inertial navigation module is at least partially applied in the azimuth correction routine.

21. The method of claim 17, further comprising generating display data based at least in part upon the track correction data, wherein the display data comprises a navigational track of the at least one user.

22. The method of claim 17, further comprising generating the rotation origin data for the inertial navigation module through a direct or indirect interaction between the inertial navigation module and a reference point determined by at least one of the inertial navigation module and an external reference.
